(19) United States
(12) Patent Application Publication
(10) Pub. No.: US 2026/0072918 A1
(43) Pub. Date: Mar. 12, 2026

(54) HARD NEGATIVE MINING FOR RE-RANKING MODELS

(71) Applicant: Oracle International Corporation, Redwood Shores, CA (US)

(72) Inventors: Hansa Meghwani, Bengaluru (IN); Amit Agarwal, Seattle, WA (US); Priyaranjan Pattnayak, Snohomish, WA (US)

(21) Appl. No.: 18/827,750

(22) Filed: Sep. 8, 2024

(51) Int. Cl. G06F 16/2457; G06F 16/22; G06F 16/28

(52) U.S. Cl. CPC G06F 16/24578; G06F 16/2237; G06F 16/285

(57) ABSTRACT

Techniques for hard negative mining for ranking models are provided. In one technique, an input document that is associated with a query is received and input to an embedding model, which outputs a document embedding (DE). Based on the document embedding, multiple embeddings are identified. Clusters of embeddings are generated from the multiple embeddings. A cluster that includes the DE is identified. Based on the DE, two sets of embeddings are identified in the cluster. For each embedding in a first set of embeddings: (1) a particular embedding (PE) is selecting from the second set of embeddings based on a similarity score between the embedding and the PE; (2) a first document that is associated with the PE is identified; and (3) a training instance that includes the first document is generated and added to training data. A model is trained based on the training data.

### TECHNICAL FIELD

The present disclosure relates to machine learning and, more particularly, to automatically generating hard negative samples for training a machine learning model.

### BACKGROUND

Large Language Models (LLMs) excel at answering questions based on the knowledge on which the LLMs were trained. However, training data for LLMs typically does not include specific private information stored on platforms like a company's Confluence, Google Drive, or SharePoint. Consequently, when queried about such private data, LLMs often fail to provide accurate or relevant responses as they lack domain/business specific data which the models have not been trained on extensively.

In the context of LLMs, Retrieval-Augmented Generation (RAG) is the process of optimizing the output of an LLM so that the LLM references an authoritative knowledge base outside of its training data sources before generating a response. LLMs are trained on vast volumes of data and use billions of parameters to generate original output for tasks like answering questions, translating languages, and completing sentences. RAG extends the already powerful capabilities of LLMs to specific domains or an organization's internal knowledge base, all without the need to retrain the LLM. RAG is a cost-effective approach to improving LLM output so that it remains relevant, accurate, and useful in various contexts.

ReAct, short for “Reasoning and Acting,” is an approach that combines reasoning traces and task-specific actions within LLMs. This integration allows an LLM to perform dynamic and context-aware decision-making, bridging the gap between reasoning and acting, which were traditionally studied as separate topics.

With RAG and ReAct, there has been an increased focus on information retrieval systems, as LLMs rely on the accuracy of retrieved documents. As mentioned previously, information retrieval systems might fail to comprehend the intricacies of private company data, hindering their ability to respond or act accurately. For example, when retrieving documents that may be relevant to a query or prompt, a RAG system leverages one or more ranking models to rank a set of candidate documents to provide an LLM along with the query. Many ranking models rank candidate documents based on embeddings that have been generated for the candidate documents and the query. Some documents may end up having similar embeddings to a query's embedding even though those documents are fundamentally different, and, as a result, the RAG system might retrieve irrelevant documents. As more and more documents are added to the RAG system, finding the right documents becomes a difficult task, which highlights the importance of retrieval and ranking models in the document retrieval pipeline.

Therefore, integrating training of ranking models with different sub-domains and categories within enterprise data rather than making generic embeddings for the domain documents is essential for these systems to effectively comprehend the complexities of organizational data and deliver meaningful results. Given a query, a positive or relevant document contains content that can be used to answer the query, while a negative or non-relevant document contains content that cannot answer the query. Ranking models are well trained to differentiate positive and negative samples based on the volume and diversity of training data, which may come via the Internet.

A hard negative document contains content that cannot be used directly to answer the query but it contains very similar keywords/semantic meanings with respect to the query, which makes it hard to differentiate. Domain experts, knowledge experts, or subject matter experts can highlight the difference between positive and hard negative documents after carefully understanding the document.

The importance of training retrieval/ranking models with hard negatives cannot be overstated, especially within enterprise domains. There are a few significant issues while training retrieval/ranking models. One, hard negatives, which are non-relevant passages that closely resemble positive examples, play a crucial role in refining the ranking model's capability to shortlist the correct document. Two, providing both positive (relevant) and negative (irrelevant) examples is important. Negative examples, especially hard negatives, push the model embeddings to distinguish between relevant and irrelevant content effectively. Negative examples also help in creating better-distinguished sub-categories and vector representations. Three, without exposure to hard negatives, a ranking model might struggle to differentiate between similar domain passages. This can lead to difficulty distinguishing between similar terminology, resulting in inaccurate retrieval and impacting the performance of other upstream models like RAG/ReAct. Given the importance of hard negatives for training, crafting accurate hard negative examples itself is a challenging problem. One approach for crafting hard negative examples is a manual approach, which is costly, slow, and prone to human error.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example system for automatically creating hard negative training samples to fine-tune ranking models for domain customization, in an embodiment;

FIG. 2 is a flow diagram that depicts an example process for identifying hard negative documents given a document that has been associated with a query, in an embodiment;

FIG. 3 is a block diagram that depicts an example system for automatically creating hard negative training samples to fine-tune ranking models for domain customization, in an embodiment;

FIG. 4 is a flow diagram that depicts an example process for generating training instances when a query is not annotated with a positive document, in an embodiment;

FIG. 5 is a block diagram that illustrates a computer system upon which an embodiment of the invention may be implemented;

FIG. 6 is a block diagram of a basic software system that may be employed for controlling the operation of the computer system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method for hard negative mining for training ranking models are provided. The system and method generate labelled data to customize/finetune ranking models for users (e.g., enterprise customers) and their specific knowledge domains. In one technique, a multi-dimensional ensemble approach is implemented with graph matching for curating the hard negatives for a given dataset containing pairs. In another technique, a different multi-dimensional ensemble approach is implemented for positive and negative data generation in case no relevant passages are labelled.

Embodiments improve computer-related technology pertaining to training ranking models. By automatically generating hard negative samples and/or positive samples, a ranking model is provided with diverse and complex cases from which to learn and its embedding space is enhanced with domain knowledge. This data is then used to customize the ranking model to enhance its ability to distinguish relevant information from similar information within the domain that might not be relevant to user queries. Improved retrieval results directly impact in-context learning and systems like RAG or ReAct Agents, which rely on relevant documents to generate responses or take actions.

While retrieval systems (e.g., for RAG/ReAct) is one use case for which embodiments may be implemented, embodiments are also applicable in other use cases, such as document understanding, topic modeling, ticket classification, and enterprise search.

### System Overview

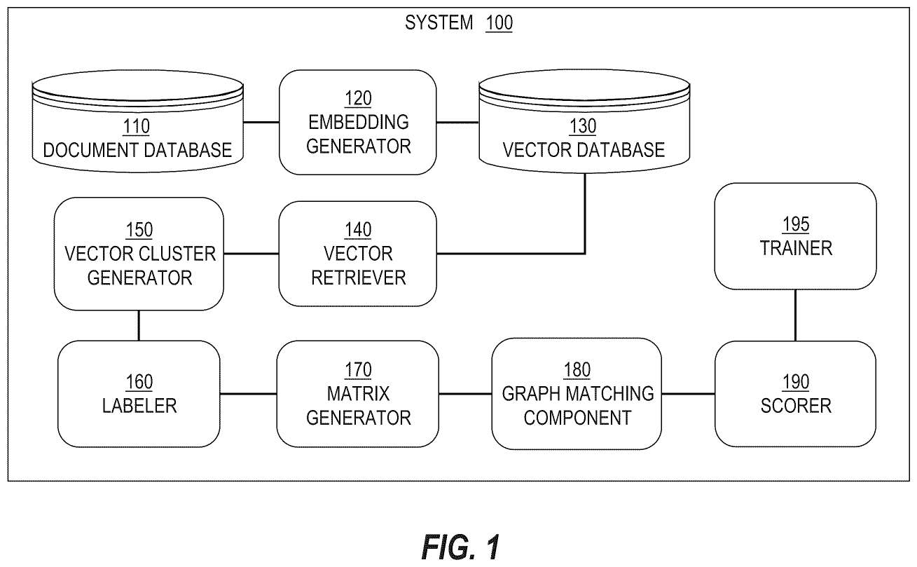

FIG. 1 is a block diagram that depicts an example system 100 for automatically creating hard negative training samples to fine-tune ranking models for domain customization, in an embodiment. System 100 includes a document database 110, an embedding generator 120, a vector database 130, a vector retriever 140, a vector cluster generator 150, a labeler 160, a matrix generator 170, a graph matching component 180, a scorer 190, and a trainer 195. Each of embedding generator 120, vector retriever 140, vector cluster generator 150, labeler 160, matrix generator 170, graph matching component 180, scorer 190, and trainer 195 is implemented in software, hardware, or any combination of software and hardware.

Document database 110 stores multiple documents. The documents may be any type of documents containing any type of data, such as text data, image data, video data, and any combination thereof. The stored documents are not limited to any particular format. For example, an image may be in gif format, jpeg format, png format, or bmp format. Documents stored in document database 110 may come from one or more sources. For example, documents may be from sources or entities that are different than the entity that owns or manages document database 110. Document database 110 may be volatile storage (e.g., DRAM or SRAM) or non-volatile storage (e.g., hard disk drives, Flash memory, or optical disks).

### Embedding Generator

Embedding generator 120 includes multiple embedding models, each of which generates a different document embedding given the same document. For example, a document that is input to a first embedding model generates a first embedding (E₁) and the same document input to a second embedding model generates a second embedding (E₂) that is different than the first embedding. A purpose of leveraging multiple embedding models for a given document is to capture diverse representations of that document.

A document embedding comprises multiple values. The multiple values may be stored in one of multiple types of data structures, an example of which is a vector. An advantage of vectors is that each entry in a vector is indexable. For example, the first position in a vector is referenced by the name of the vector plus a ‘1’, such as vector_a[1]. Thus, herein, “vector” is synonymous with document embedding. Each vector (or document embedding) is stored in vector database 130.

Each embedding model is trained based on a different set of data, thus ensuring that each embedding model produces a different embedding based on the same input. In an embodiment, the embedding models have no more than a threshold percentage of overlap of their respective training data. For example, no more than 25% of the training data that is used to train a first embedding model is used to train a second embedding model. Otherwise, similar embeddings would be produced by the two embedding models given the same document as input.

Different embedding models may have different dimension sizes and context window sizes. The dimension size of an embedding model refers to the number of values that the embedding model outputs for a given input. The context window of an embedding model refers to the number of characters or tokens that may be input to the embedding model. A document with 1024 tokens and an embedding model that captures 512 tokens will create two vectors, which will be concatenated to create the document embedding.

In an embodiment, if an embedding model generates multiple embeddings for a given document, then the embeddings are concatenated to create a document embedding. This is done instead of averaging the embeddings that are generated by the same embedding model for a given document.

In an embodiment, individual embeddings (generated by different embedding models) are concatenated to generate an ensemble embedding (E_{E}), which is also stored as a vector in vector database 130. An alternative way to generate an ensemble embedding is to average multiple embeddings together, where the values in the first entries of the multiple embeddings are averaged and the result stored in the first entry of the ensemble embedding, the values in the second entries of the multiple embeddings are averaged and the result is stored in the second entry of the ensemble embedding, and so forth.

Therefore, input to embedding generator 120 is a set of documents (e.g., from document database 110) and a set of N embedding models. Output of embedding generator 120 is multiple pairs, each comprising (1) a different document (D) and (2) a set of embeddings generated by the set of N embedding models given that document as input: {D, <E₁, E₂, . . . , Eₙ, E_{E}>}. Each pair is stored in vector database 130.

### Query-Document Pair

In order to leverage vector database 130 to find hard negative samples for training a ranking model, a query and a document are provided as input. The document may be manually selected as an example document that is pertinent to the query. For example, the document may be selected as a good example of the document that a ranking model should rank highly (or ultimately select for input to an LLM) given the query as input. For one or more query-document pairs, an entity that owns or operates system 100 selects the document for the given query. Additionally or alternatively, for one or more query-document pairs, a user that submitted a query provided positive feedback (e.g., selecting, rating, and/or saving a result that a search system generated for the query).

### Vector Retriever

Given an input document, vector retriever 140 retrieves a set of vectors from vector database 130. Again, each vector corresponds to a document and was generated by one of multiple embedding models. Vector retriever 140 (or another component of system 100) causes a set of N vectors to be generated for the input document (and based on the input document), one vector from each embedding model of N embedding models in embedding generator 120. Additionally, an ensemble embedding/vector may be generated for the input document (based on the outputs, from the N embedding models, that are based on the input document). For example, if there are three embedding models, then vector retriever 140 may generate four vectors for an input document, one vector for each of the three embedding models and one vector for the embedding ensemble.

For each “input” vector generated based on the input document, vector retriever 140 uses that input vector to identify a set of vectors that are similar to that input vector. Each vector in the set of vectors was generated by the same embedding model that generated the input vector. Vector retriever 140 may retrieve a pre-defined number of vectors or may retrieve only vectors that are within a pre-defined distance threshold from the input vector. Example distance measurements include cosine distance, Hamming distance, dot product distance, Manhattan distance, and squared Euclidian distance.

In order to identify a set of vectors to retrieve from vector database 130, vector retriever 140 may compute a distance between the input vector and each applicable vector (i.e., generated by the same embedding model that generated the input vector) in vector database 130. Alternatively, vector retriever 140 may consider a strict subset of the applicable vectors, such as a random sampling of 10% of the applicable vectors, if the number of applicable vectors is significantly high. Alternatively, vector retriever 140 may leverage a vector index (such as an HNSW index) in order to avoid a scan of all those vectors.

### Vector Cluster Generator

For each generated vector for the input document (also referred to as the “input vector”), vector cluster generator 150 generates a cluster of vectors based on the vectors that were generated by the same embedding model that generated the input vector. Example clustering techniques include OPTICS (Ordering Points To Identify the Clustering Structure), DBSCAN (Density-based spatial clustering of applications with noise), and HDBSCAN (Hierarchical Density-Based Spatial Clustering of Applications with Noise).

For each embedding model, vector cluster generator 150 may generate multiple clusters of vectors that were generated by that embedding model (and that were retrieved by vector retriever 140). The vector of the input document (referred to herein as the “input document vector”) is assigned to one of the multiple clusters. (This cluster may be referred to as the “input document cluster.”) Similarly for the ensemble embedding, vector cluster generator 150 may generate multiple clusters of vectors, or of ensemble embeddings.

For each embedding model, each document corresponding to a vector in the input document cluster is a candidate for being a positive document or a hard negative document. (The documents associated with vectors that are not in the input document cluster are considered negative documents, or “easy” negative documents.) The greater the distance of a vector to the input document vector, the less relevant the document of the vector is to the input document. Conversely, the closer that two vectors are in vector space, the closer the respective documents are semantically similar. Thus, within the input document cluster, vectors that are very close (e.g., within a threshold distance) to the input document vector are considered positives (or “core samples”) while vectors that are not as close to the input document vector are considered “non-core samples” and are candidates for being hard negatives. The specific clustering technique itself may identify core samples and non-core samples so that no extra thresholding needs to be tested and implemented. Ultimately, some embodiments only select a strict subset of the non-core samples as hard negative samples.

### Labeler

Labeler 160 assigns a label to multiple non-core samples (or candidate hard negative samples) and, optionally, to one or more core samples. Thus, the clustering may be used to identify additional documents that are very similar to the input document and that can be used to supplement the training of a ranking model with additional positive samples. Labeler 160 may assign a −1 to each non-core sample while assigning a 1 to each selected core sample, including the input document. Labeler 160 may also assign a label to easy negative samples, which correspond to vectors that were identified outside of the input document cluster.

### Matrix Generator

Matrix generator 170 generates an N×M matrix, where N is the number of core samples (or positive documents) that were identified or selected and M is the number of non-core samples that were identified or selected. The value in each cell of the matrix is a 1-similarity score (“one minus the similarity score”), where the “similarity score” is a similarity measurement between the core sample that corresponds to that cell and the non-core sample that corresponds to that cell. Examples of similarity measurements include cosine similarity, Euclidean distance, and dot product. Additionally, scores from different similarity measurements may be averaged to capture different relationships. Table 1 is an example of an N×M matrix that matrix generator 170 generates where there are two positive documents and four non-core samples:

TABLE 1

| | NC1 | NC2 | NC3 | NC4 |
|---|---|---|---|---|
| PD1 | 0.5 | 0.7 | 0.3 | 0.1 |
| PD2 | 0.5 | 0.6 | 0.2 | 0.9 |

Given a query-document pair, matrix generator 170 generates a different N×M matrix for each embedding model in embedding generator 120 and, optionally, another N×M matrix for the ensemble embedding.

### Graph Matching Component

Graph matching component 180 matches each core sample (or positive document) in an N×M matrix with one non-core sample (or candidate hard negative sample). In this way, no non-core sample is selected multiple times as a hard negative sample. Selecting a document two or more times as a sample is not a good practice for model training purposes. Models are best trained using different and varying samples.

One example graph matching technique is bi-partite graph matching in order to create a 1-to-1 match between a positive document and a non-core sample. A goal of bi-partite graph matching is to minimize the overall “cost” of the selected non-core samples. The “cost” of a non-core sample may be the value in the cell of the N×M matrix. Thus, a set of non-core samples are selected that have the lowest cost relative to each other possible set of non-core samples that could have been selected and all of the non-core samples selected together.

For example, given the matrix in Table 1, non-core sample NC4 is selected as a hard negative sample for positive document PD1 and non-core sample NC3 is selected as a hard negative sample for positive document PD2. Any other combination of non-core samples selected for positive documents PD1 and PD2 would have a higher cost. Thus, an output of graph matching technique based on table 1 is {PD1:NC4, PD2:NC3}.

Graph matching component 180 performs positive document-to-non-core sample matching for each generated matrix. For example, if matrix generator 170 generated three matrices in response to a single query-positive document pair, then output from graph matching component 180 based on the three matrices may be the following: {PD1:[NC4, NC1, . . . ], PD2:[NC3, NC2, . . . ]}. Thus, after graph matching component 180, each positive document is associated with multiple non-core samples, which are candidate hard negative samples.

### Scorer and Trainer

Scorer 190 scores a set of non-core samples that have been associated with the one or more positive documents that have been identified after the graph matching step. One criterion in which to score multiple non-core samples associated with the one or more positive documents (which non-core samples were chosen based on different underlying embedding models) is to identify the ensemble embedding associated with each non-core sample and generate a similarity score between that ensemble embedding and an ensemble embedding of the query. The ensemble embedding of the query was also generated based on each embedding model in embedding generator 120. The top K non-core samples that are associated with the highest similarity scores may be selected as hard negative documents. K is a hyper-parameter and may be greater than one.

For example, given nine different non-core samples that have been identified across three different matrices, scorer 190 generates nine different scores, one for each of the nine non-core samples. Scorer 190 (or another component of system 100) identifies the top K (e.g., four) scores from the nine scores and identifies the non-core sample that is associated with each identified score. As a result, K hard negative samples are generated, one for each non-score sample whose score was selected. In a related example, less than the maximum number of non-core samples are identified (i.e., less than the number of matrices * the number of positive documents), which is possible if at least one non-core sample is a top sample across multiple matrices.

As another example, instead of relying solely (or at least partially) on the K non-core samples with the highest similarity scores, the non-core sample that appears in the most positive document lists (at the end of the graph matching stage) may be selected as a hard negative sample. For example, if NC2 appears in lists of four different positive documents and no other non-core sample appears in more than two of such lists, then NC2 is selected as a hard negative sample, even if NC2 is not in the top K of highest similarity scores with the (e.g., ensemble) embedding of the query.

If multiple non-core samples are selected for each positive document, then there is a risk that the same non-core sample might be assigned to multiple positive documents and cause confusion. In an embodiment, for smaller datasets, a single non-core sample is selected for one positive document. For larger datasets, multiple non-core samples are selected for one positive document in order to increase variability.

Trainer 195 trains a model based, at least in part, the hard negative samples that have been identified. The model may be a ranking model that ranks a set of candidate documents given a query as input. The training data that trainer 195 uses to train the model comprises multiple training instances. At least some of the training instances are based on (or include) the hard negative samples. Each of these training instances comprises the query that is associated with the input document, a different hard negative sample, and the input positive document, or a core sample. Example machine learning techniques include supervised learning with Triplet Ranking Loss, self-supervised learning (e.g., Masked Language Modeling (MLM) with Next Sentence Prediction (NSP)), and Reinforcement learning.

Trainer 195 may also train the model based on the positive documents that were identified after the clustering stage. Thus, each training instance of one or more training instance may include the query and a different one of the positive documents that were identified. Similarly, trainer 195 may train the model based on easy negative samples that were also identified after the clustering stage.

In an embodiment where easy negative samples and hard negative samples are used to train the model, the hard negative samples and the easy negative samples are weighted differently during training. For example, hard negative samples may be weighted higher than easy negative samples. This difference in weighting may help the model to learn to distinguish better from hard negative samples.

In an embodiment, trainer 195 (or another component of system 100) stores the trained model in memory, such as non-volatile memory. The trained model may be retrieved later for execution in production, for example, as part of a pipeline. Additionally or alternatively, the trained model is deployed immediately (which may involve storing the trained model in volatile memory) so that the trained model may be used in production. Alternatively, the trained model is the subject of further testing before being put into production.

### Example Process

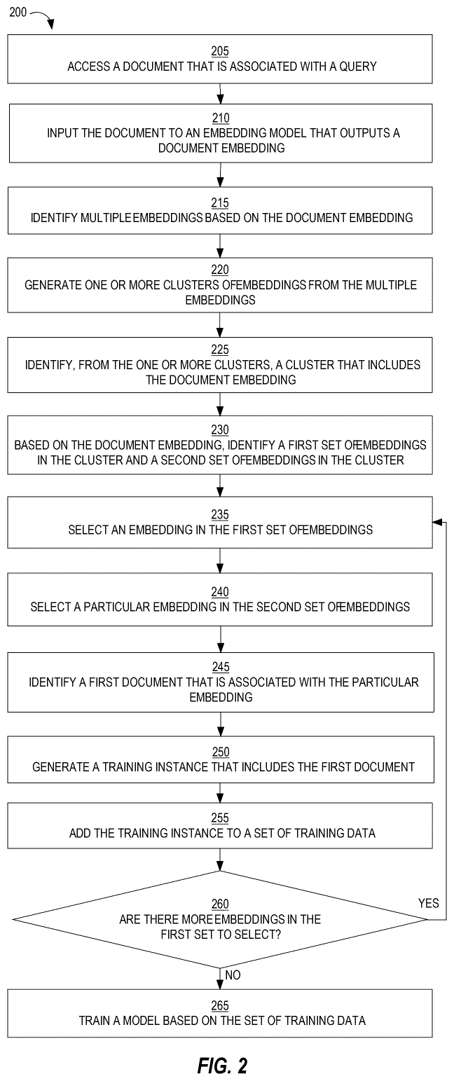

FIG. 2 is a flow diagram that depicts an example process 200 for identifying hard negative documents given a document that has been associated with a query, in an embodiment. Process 200 may be performed by different components of system 100.

At block 205, an input document that is associated with a query is accessed. The input document was manually associated with the query. Block 205 may involve embedding generator 120 receiving (directly or indirectly through one or more components (not shown) of system 100) the query and the input document in a request from a computing device operated by a user.

At block 210, the input document is input to an embedding model that outputs a document embedding. If multiple embedding models are used, then block 210 involves inputting the input document into each embedding model of the multiple embedding models, resulting in multiple embeddings being generated. Block 210 may be performed by embedding generator 120.

At block 215, based on the document embedding, multiple embeddings are identified. Block 215 may be performed by vector retriever 140.

At block 220, one or more clusters of embeddings are generated from the plurality of embeddings. Block 220 may be performed by vector cluster generator 150.

At block 225, a cluster, from the one or more clusters, that includes the document embedding is identified. Block 225 may be performed by vector cluster generator 150 or labeler 160.

At block 230, based on the document embedding, a first set of embeddings is identified in the cluster and a second set of embeddings in the cluster is identified. Each embedding in the first set of embeddings is considered a “core” embedding and its corresponding document (from which the embedding was generated) is a candidate for being an additional positive document for training purposes. Each embedding in the second set of embeddings is considered a “non-core” embedding and its corresponding document (from which the embedding was generated) is a candidate for being hard negative document for training purposes.

At block 235, an embedding in the first set of embeddings is selected. This selection may be random or may involve selecting the first embedding in the first set of embeddings.

At block 240, a particular embedding in the second set of embeddings is selected. This selection may be based on one or more factors, such as a similarity score between the embedding and the particular embedding.

Instead of selecting one embedding from the first set of embeddings at a time as suggested in process 200, blocks 235-240 may involve performing bi-partite graph matching that results in matching each embedding in the first set of embeddings to an embedding in the second set of embeddings. Such matching may be based on a similarity between each embedding in the first set of embeddings and each embedding in the second set of embeddings.

At block 245, a first document that is associated with the particular embedding is identified. Block 245 may be performed multiple times before block 250, such that multiple documents are identified, each corresponding to multiple embeddings from the second set of embeddings.

At block 250, a training instance that includes the first document is generated. Block 250 may comprise including the query in the training instance and, optionally, the input document or a document that corresponds to the selected embedding in block 235. If multiple documents are identified in block 245, then block 250 may involve generating a different training instance based on each identified document.

At block 255, the training instance is added to a set of training data, which may be initially empty at the beginning of process 200.

At block 260, it is determined whether there are any more embeddings in the first set of embeddings to select. If so, then process 200 returns to block 235; otherwise, process 200 proceeds to block 265. Block 260 may be skipped if blocks 235-240 match all the embeddings in the first set with embeddings in the second set prior to generating a training instance for any documents associated with embeddings in the second set.

At block 265, a model is trained based on the set of training data. The training involves using one or more machine learning techniques to train the model based on the set of training data.

### System Overview: No Positive Input Document

In the case where no positive input document is available for a query, query embeddings and different embedding models are leveraged to identify consistent positive samples and/or hard negative samples. Thus, embodiments allow entities (e.g., customers or enterprise users) to label/augment their dataset for effective training of a retrieval/ranking model even if a labeled positive document is not available. In other words, embodiments allow for unsupervised labeling. In contrast, current approaches involve only training on a dataset with positive labeled documents.

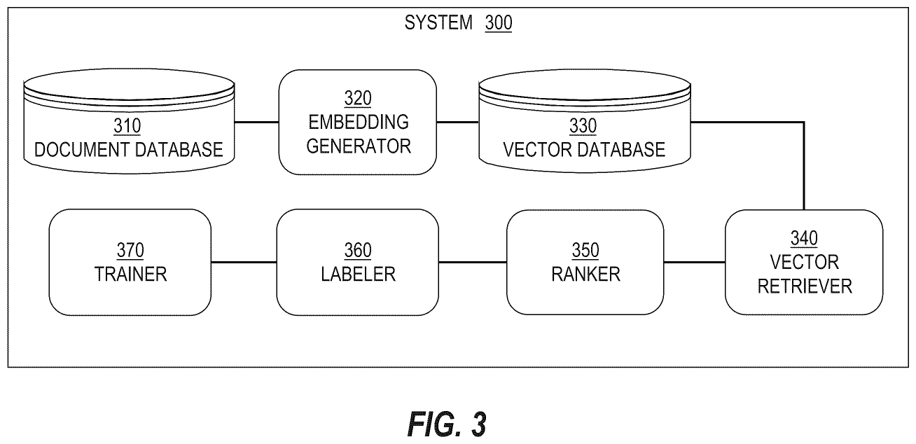

FIG. 3 is a block diagram that depicts an example system 300 for automatically creating hard negative training samples to fine-tune ranking models for domain customization, in an embodiment. System 300 includes a document database 310, an embedding generator 320, a vector database 330, a vector retriever 340, a ranker 350, a labeler 360, and a trainer 370. Each of embedding generator 320, vector retriever 340, ranker 350, labeler 360, and trainer 370 is implemented in software, hardware, or any combination of software and hardware. Document database 310 is the same as or similar to document database 110, embedding generator 320 is the same as or similar to embedding generator 120, vector database 330 is the same as or similar to vector database 130, vector retriever 340 is the same as or similar to vector database 140, and trainer 370 is the same as or similar to trainer 195.

Embedding generator 320 generates multiple embeddings for a query or prompt. Each embedding is generated by a different embedding model in embedding generator 320, where the same query is input to each embedding model. Thus, if embedding generator 320 comprises three embedding models, then embedding generator 320 generates three embeddings for a query.

For each generated query embedding, vector retriever 340 retrieves a set of vectors from vector database 130. For example, vector retriever 340 retrieves, from vector database 130, the top N (e.g., one thousand) vectors that are most similar to the generated query embedding that represents the query. As another example, vector retriever 340 retrieves, from vector database 130, a set of vectors whose similarity scores are under (or over, depending on the implementation) a pre-defined similarity threshold. As another example, both restrictions (maximum number and similarity threshold) are used when retrieving vectors from vector database 130.

Because embedding generator 320 generates multiple embeddings for a single query, vector retriever 340 may retrieve a different set of vectors from vector database 330. However, there may be significant overlap between the different sets of vectors, meaning that each set of vectors may have many documents in common. Also, some documents may be associated with only one of the sets of vectors or a strict subset of the sets of vectors.

An example set of scores that vector retriever 340 generates for each embedding model-query embedding-document embedding triplet is as follows:

TABLE 2

| | Emb1 | Emb2 | Emb3 |
|---|---|---|---|
| Q1D1 | 0.98 | 0.95 | 0.79 |
| Q1D2 | 0.87 | 0.67 | 0.67 |
| Q1D3 | 0.66 | 0.90 | 0.55 |

In this example, the three embedding models that were used by embedding generator 320 are referred to as “Emb1,” “Emb2,” and “Emb3.” The query is referred to as “Q1” and the different documents whose identifiers or references were retrieved from vector database 330 are referred to as “D1,” “D2,” and “D3.” Also in this example, at least three documents were retrieved for each of the three embeddings of the query. Thus, a similarity score is available for each triplet. In this example, the closer the similarity score is to 1.0, the closer the match between the query and the document. Other similarity scoring techniques may not have a maximum score or a minimum score (e.g., 0.0).

Ranker 350 generates a separate ranking for each set of vectors. If embedding generator 320 leverages three embeddings models, then ranker 350 generates three different set rankings. Each set ranking comprises multiple individual rankings pertaining to a query-document pair. An example of multiple set rankings based on the similarity scores in Table 2 is as follows:

TABLE 3

| | Emb1 | Emb2 | Emb3 |
|---|---|---|---|
| Q1D1 | 1 | 1 | 1 |
| Q1D2 | 2 | 3 | 2 |
| Q1D3 | 3 | 2 | 3 |

Each set ranking corresponds to a different embedding model. Ranker 350 then computes a document score for a document that is based on multiple individual rankings of that document. In the above example, document D1 has three first place rankings, document D2 has two second place rankings and one third place ranking, and document D3 has two third place rankings and one second place ranking. The individual rankings of a given query embedding-document embedding pair are combined to generate the document score. Such a combination may be performed in multiple ways, such as computing an average or a median, or computing an average of the reciprocal rank. An example of the latter is shown in the following table:

TABLE 4

| | Ranks | Ranks | Ranks | |
|---|---|---|---|---|
| | Emb1 | Emb2 | Emb3 | Document Score |
| Q1D1 | 1 | 1 | 1 | (1/1 + 1/1 + 1/1)/3 = 1 |
| Q1D2 | 2 | 3 | 2 | (1/2 + 1/3 + 1/2)/3 = 0.443 |
| Q1D3 | 3 | 2 | 3 | (1/3 + 1/2 + 1/3)/3 = 0.386 |

Labeler 360 assigns a label to each of one or more candidate documents based on a document score of those one or more candidate documents. For example, because document D1 has the highest document score, labeler 360 may assign a positive label to document D1 so that document D1 will be included in a positive training instance that includes the query. If a “regular” average is computed of multiple individual rankings of a given query-document pair (instead of computing an average of the reciprocal rank), then labeler 360 may assign the document with the lowest document score as a positive document.

In an embodiment, a threshold document score is used to select a candidate document as a positive document for training. For example, two thresholds may be applied at the same time: (1) a 95% percentile threshold for at least one embedding model (meaning documents with scores in the 95% percentile or higher for any one embedding model are selected as candidate positive documents) and (2) a 90th percentile across all embedding scores where this percentile score is an average of percentile scores associated with different embedding models. For example, a document may have a 75% percentile score, a 98% percentile score, and a 88% percentile score. Because the average (87%) is less than 90%, this document is not considered a positive document. Documents that meet both thresholds together are used as positive documents. Applying these thresholds to other documents may result in N documents. All N documents may be used as positive documents in training. Alternatively, a subset of the N documents may be selected for training. For example, the N documents may be ranked based on their average percentile score across all embeddings and then the top K are selected for training as positive documents.

Similarly, because document D3 has the lowest score (or has a document score that is lower than a minimum score threshold), labeler 360 may label document D3 as a negative document to be included in a negative training instance that includes the query.

In an embodiment, a hard negative document is identified by applying the two thresholds described previously. For example, a hard negative document may be one where the document is in the 95th percentile for at least one of the embedding models and is less than the 90th percentile of the average of the embedding models. This shows that the document is very similar according to some embedding model but on average is less similar making it a hard negative document. Applying these two thresholds may result in identifying multiple hard negative documents. All identified hard negative documents may be used to train a model; Alternatively, only a strict subset of the hard negatives documents that are identified yusing this technique are selected for training the model. The strict subset may be identified by sorting the N hard negative documents based on a deviation measurement (e.g., standard deviation) across different embedding models and selecting the top K. Sorting based on a deviation measurement highlights hard negatives documents as they are confusing samples for different embedding models, which documents can help improve the model that is trained based on those hard negative documents. The deviation measurement is derived based on the multiple similarity scores associated with the candidate document. An example of a deviation measurement is a standard deviation. The standard deviation is a measure of how dispersed a set of data is in relation to the mean (or average) of that set of data. Low, or small, standard deviation indicates that the set of data is clustered tightly around the mean, whereas high, or large, standard deviation indicates that the set of data is more spread out. If the deviation measurement is higher than a particular threshold, then labeler 360 may assign the corresponding candidate document as a hard negative document that will be included in a negative training instance that includes the query.

Trainer 370 (or another component of system 300) generates training instances based on the labels assigned to candidate documents. For example, some candidate documents may be assigned a positive label, others a hard negative label, and others an easy negative label. Some candidate documents may not be assigned any label and, therefore, training instances will not be generated for those candidate documents. Based on the assigned label of a candidate document, a training instance is generated that includes that the query, the candidate/positive document, and the hard negative document. Instead of single positive document, a training instance may contain multiple positive documents. Also, instead of a single hard negative document, a training instance may contain multiple hard negative documents. After or while multiple training instances are generated based on the candidate documents with assigned labels, trainer 370 uses one or more machine learning techniques to train a model (e.g., a neural network) based on the generated training instances.

### Example Process

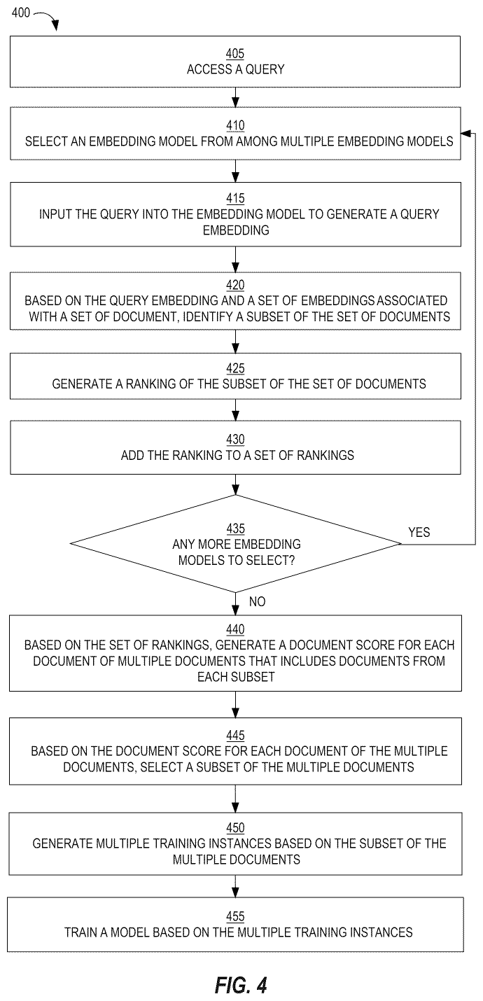

FIG. 4 is a flow diagram that depicts an example process 400 for generating training instances when a query is not annotated with a positive document, in an embodiment. Process 400 may be performed by different components of system 300.

At block 405, a query is accessed. The query may be a query that is stored in local storage of system 300. Alternatively, system 300 receives the query from a computing device that is operated by a user.

At block 410, an embedding model from among multiple embedding models is selected. The order in which the embedding model is selected may be random. Block 410 may be performed by embedding generator 320.

At block 415, the query is input into the selected embedding model to generate a query embedding. Block 415 may be performed by embedding generator 320.

At block 420, based on the query embedding and a set of embeddings associated with a set of documents, a subset, of the set of documents, is identified that are semantically similar to the query embedding. For example, the top N documents whose embeddings (generated by the same selected embedding model) are most similar to the query embedding are retrieved from a database of embeddings, such as vector database 330. Block 420 may be performed by vector retriever 340.

At block 425, a ranking of the subset of the set of documents is generated. Block 425 may be performed by ranker 350 and is based on similarity scores used to retrieve the subset of the documents. The ranking may be from highest similarity score to lowest similarity score or vice versa.

At block 430, the ranking is added to a set of rankings. Initially, the set of rankings is empty. After two iterations of process 400 for a given query, the set of rankings comprises multiple rankings.

At block 435, it is determined whether there are any more embedding models to select. If so, then process 400 returns to block 410; otherwise, process 400 proceeds to block 440. Alternatively, block 410 may involve selecting all appropriate embedding models in parallel. Thus, for example, one thread or process performs blocks 415-430 given one embedding model and another thread or process performs blocks 415-430 given another embedding model. Thus, each thread or process performs blocks 415-430 separately from the other thread(s)/process(es).

At block 440, based on the set of rankings, a document score for each document of multiple documents that includes documents from each subset is generated. The document score of a document may be based on the multiple individual rankings of that document among the different set of rankings. For example, an average of the individual rankings or an average of the reciprocal rankings may be computed. Block 440 may be performed by ranker 350 or another component of system 300.

At block 445, based on the document score for each document of the plurality of documents, a subset of the multiple documents is selected. For example, the documents with the lowest document scores and/or documents with the highest document scores are selected. If the metric of the document score is average rank, then the documents with the lowest documents scores may be considered positive documents and the documents with the highest document scores may be considered negative documents. If the metric of the document score is average of the reciprocal rank, then the documents with the lowest documents scores may be considered negative documents and the documents with the highest document scores may be considered positive documents. The documents that are associated with the highest deviation measurement (e.g., standard deviation) may be considered hard negative documents. Thus, block 445 may involve identifying multiple, non-overlapping subsets: one for positive documents, one for hard negative documents, and, optionally, one for easy negative documents.

At block 450, multiple training instances are generated based on the subset of the multiple documents. If multiple subsets are identified, then training instances are generated for the documents in each subset. Block 450 may be performed by ranker 350 or another component of system 300.

At block 455, a model is trained based on the multiple training instances. Block 455 may be performed by trainer 370.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

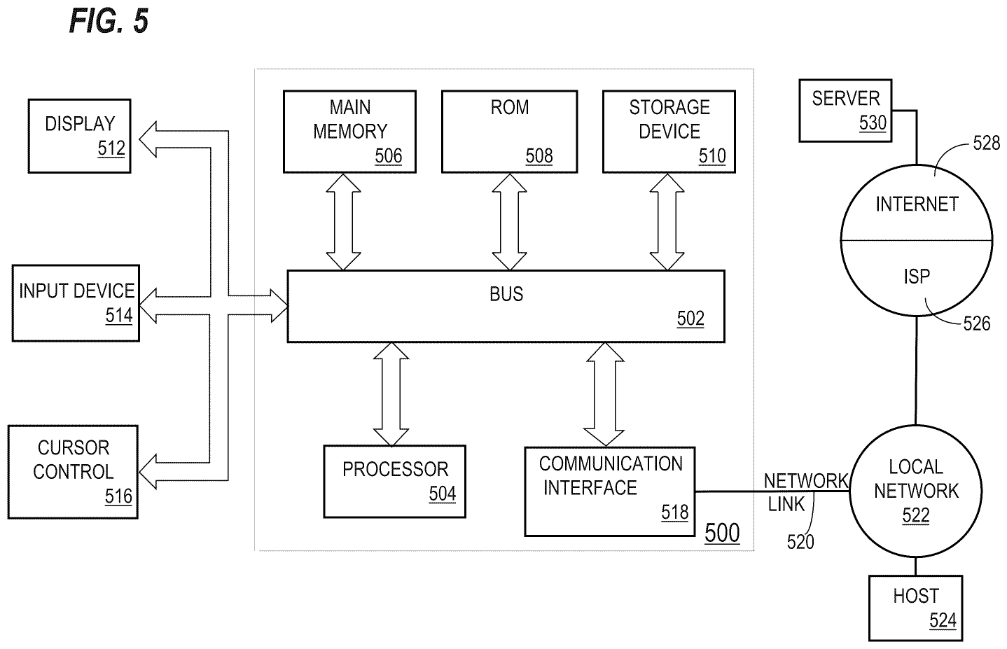

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or solid-state drive is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 510. Volatile media includes dynamic memory, such as main memory 506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic, or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the worldwide packet data communication network now commonly referred to as the “Internet” 528. Local network 522 and Internet 528 both use electrical, electromagnetic, or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### Software Overview

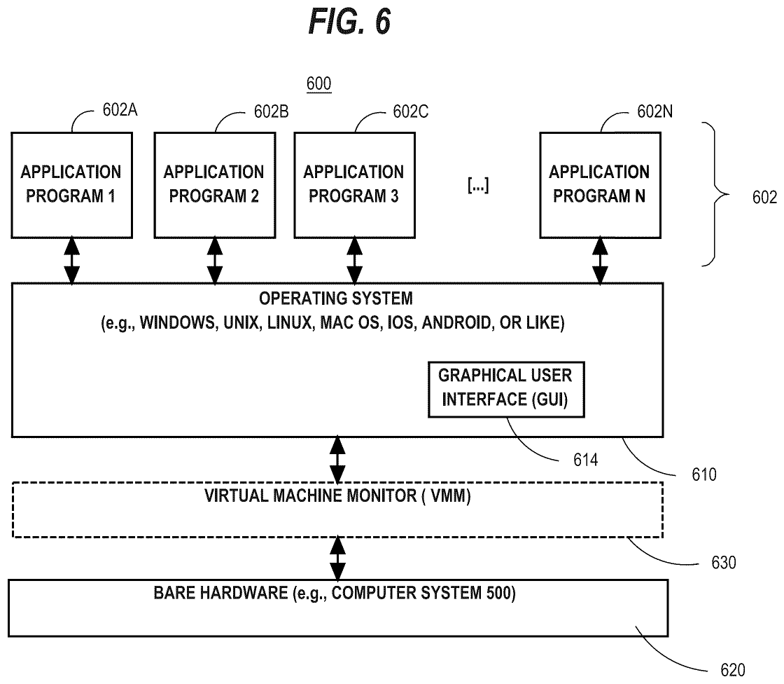

FIG. 6 is a block diagram of a basic software system 600 that may be employed for controlling the operation of computer system 500. Software system 600 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 600 is provided for directing the operation of computer system 500. Software system 600, which may be stored in system memory (RAM) 506 and on fixed storage (e.g., hard disk or flash memory) 510, includes a kernel or operating system (OS) 610.

The OS 610 manages low-level aspects of computer operation, including managing execution of processes, memory allocation, file input and output (I/O), and device I/O. One or more application programs, represented as 602A, 602B, 602C . . . 602N, may be “loaded” (e.g., transferred from fixed storage 510 into memory 506) for execution by the system 600. The applications or other software intended for use on computer system 500 may also be stored as a set of downloadable computer-executable instructions, for example, for downloading and installation from an Internet location (e.g., a Web server, an app store, or other online service).

Software system 600 includes a graphical user interface (GUI) 615, for receiving user commands and data in a graphical (e.g., “point-and-click” or “touch gesture”) fashion. These inputs, in turn, may be acted upon by the system 600 in accordance with instructions from operating system 610 and/or application(s) 602. The GUI 615 also serves to display the results of operation from the OS 610 and application(s) 602, whereupon the user may supply additional inputs or terminate the session (e.g., log off).

OS 610 can execute directly on the bare hardware 620 (e.g., processor(s) 504) of computer system 500. Alternatively, a hypervisor or virtual machine monitor (VMM) 630 may be interposed between the bare hardware 620 and the OS 610. In this configuration, VMM 630 acts as a software “cushion” or virtualization layer between the OS 610 and the bare hardware 620 of the computer system 500.

VMM 630 instantiates and runs one or more virtual machine instances (“guest machines”). Each guest machine comprises a “guest” operating system, such as OS 610, and one or more applications, such as application(s) 602, designed to execute on the guest operating system. The VMM 630 presents the guest operating systems with a virtual operating platform and manages the execution of the guest operating systems.

In some instances, the VMM 630 may allow a guest operating system to run as if it is running on the bare hardware 620 of computer system 500 directly. In these instances, the same version of the guest operating system configured to execute on the bare hardware 620 directly may also execute on VMM 630 without modification or reconfiguration. In other words, VMM 630 may provide full hardware and CPU virtualization to a guest operating system in some instances.

In other instances, a guest operating system may be specially designed or configured to execute on VMM 630 for efficiency. In these instances, the guest operating system is “aware” that it executes on a virtual machine monitor. In other words, VMM 630 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

The above-described basic computer hardware and software is presented for purposes of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
receiving an input document that is associated with a query;
generating a document embedding using an embedding model and the input document as input to the embedding model;
based on the document embedding, identifying a plurality of embeddings;
generating one or more clusters of embeddings from the plurality of embeddings;
identifying a cluster, from the one or more clusters, that includes the document embedding;
based on the document embedding, identifying, in the cluster, a first set of embeddings and a second set of embeddings;
for each embedding in the first set of embeddings:
selecting, from the second set of embeddings, a particular embedding based on a similarity score between said each embedding and the particular embedding;
identifying a first document that is associated with the particular embedding;
generating a training instance that includes the first document;
adding the training instance to a set of training data;
training a model based on the set of training data;
wherein the method is performed by one or more computing devices.

2. The method of claim 1, further comprising, prior to training the model, including the query in the training instance.

3. The method of claim 1, further comprising:
for each embedding in the first set of embeddings:
generating a plurality of similarity scores, each similarity score indicating a similarity between said each embedding and a different embedding in the second set of embeddings;
wherein selecting the particular embedding is based on the plurality of similarity scores.

4. The method of claim 3, wherein:
the first set of embeddings includes multiple embeddings;
the method further comprising performing bi-partite graph matching to create a 1-to-1 match between each embedding in the first set of embeddings and a different embedding in the second set of embeddings;
selecting the particular embedding is based on the 1-to-1 match.

5. The method of claim 1, wherein the embedding model is one of a plurality of embedding models, the method further comprising:
for each embedding model of the plurality of embedding models:
generating a particular embedding using said each embedding model and the input document as input to said each embedding model;
based on the particular embedding, identifying a particular plurality of embeddings;
generating one or more particular clusters of embeddings from the particular plurality of embeddings;
identifying a particular cluster, from the one or more particular clusters, that includes the particular embedding;
based on the particular embedding, identifying, in the cluster, a first particular set of embeddings and a second particular set of embeddings;
for each embedding in the first particular set of embeddings:
selecting, from the second particular set of embeddings, a certain embedding based on a similarity score between said each embedding an the certain embedding;
identifying a first particular document that is associated with the certain embedding;
generating a particular training instance that includes the first particular document;
adding the particular training instance to the set of training data.

6. The method of claim 1, wherein the second set of embeddings is a first subset of a first plurality of embeddings that were identified in the cluster based on the document embedding, the method further comprising:
identifying a second subset of the first plurality of embeddings;
identifying a set of ensemble embeddings that correspond to the second subset;
based on the query, generating a query embedding that represents the query;
for each ensemble embedding in the set of ensemble embeddings:
generating a similarity score between said each ensemble embedding and the query embedding;
adding the similarity score to a set of similarity scores;
selecting a subset of the set of similarity scores;
identifying a plurality of documents that are associated with the subset;
generating a plurality of training instances based on the plurality of documents;
adding the plurality of training instances to the set of training data.

7. The method of claim 6, wherein the query embedding is an ensemble embedding that is based on multiple embeddings that were generated based on output from each embedding model of a plurality of embedding models that includes the embedding model.

8. The method of claim 1, further comprising:
identifying a subset of the first set of embeddings;
identifying a plurality of positive documents that are associated with the subset;
generating a plurality of training instances based on the plurality of positive documents;
adding the plurality of training instances to the set of training data.

9. A method comprising:
in response to accessing a query, for each embedding model of a plurality of embedding models:
inputting the query into said each embedding model to generate a query embedding;
based on the query embedding and a set of embeddings associated with a set of documents, identify a subset of the set of documents;
generating a ranking of the subset of the set of documents;
adding the ranking to a plurality of rankings;
based on the plurality of rankings, generating a document score for each document of a plurality of documents that includes documents from each subset;
based on the document score for each document of the plurality of documents, selecting a subset of the plurality of documents;
generating a plurality of training instances based on the subset of the plurality of documents;
training a model based on the plurality of training instances;
wherein the method is performed by one or more computing devices.

10. The method of claim 9, wherein selecting the subset of the plurality of documents comprises selecting documents, from the plurality of documents, that have the highest document scores.

11. The method of claim 9, further comprising:
based on the plurality of rankings, generating a deviation measurement for each document of the plurality of documents;
wherein selecting the subset of the plurality of documents is further based on the deviation measurement for each document of the plurality of documents.

12. The method of claim 9, further comprising:
identifying a plurality of embeddings, of the query, that were generated by the plurality of embedding models;
generating an ensemble embedding based on the plurality of embeddings;
based on the ensemble embedding and a set of ensemble embeddings associated with the set of documents, identifying a particular subset of the set of documents;
generating a particular ranking of the particular subset;
adding the particular ranking to the set of rankings.

13. One or more non-transitory storage media storing instructions which, when executed by one or more computing devices, cause:
receiving an input document that is associated with a query;
generating a document embedding using an embedding model and the input document as input to the embedding model;
based on the document embedding, identifying a plurality of embeddings;
generating one or more clusters of embeddings from the plurality of embeddings;
identifying a cluster, from the one or more clusters, that includes the document embedding;
based on the document embedding, identifying, in the cluster, a first set of embeddings and a second set of embeddings;
for each embedding in the first set of embeddings:
selecting, from the second set of embeddings, a particular embedding based on a similarity score between said each embedding and the particular embedding;
identifying a first document that is associated with the particular embedding;
generating a training instance that includes the first document;
adding the training instance to a set of training data;
training a model based on the set of training data;
wherein the method is performed by one or more computing devices.

14. The one or more storage media of claim 13, wherein the instructions, when executed by the one or more computing devices, further cause, prior to training the model, including the query in the training instance.

15. The one or more storage media of claim 13, wherein the instructions, when executed by the one or more computing devices, further cause:
for each embedding in the first set of embeddings:
generating a plurality of similarity scores, each similarity score indicating a similarity between said each embedding and a different embedding in the second set of embeddings;
wherein selecting the particular embedding is based on the plurality of similarity scores.

16. The one or more storage media of claim 15, wherein:
the first set of embeddings includes multiple embeddings;
the instructions, when executed by the one or more computing devices, further cause performing bi-partite graph matching to create a 1-to-1 match between each embedding in the first set of embeddings and a different embedding in the second set of embeddings;
selecting the particular embedding is based on the 1-to-1 match.

17. The one or more storage media of claim 13, wherein the embedding model is one of a plurality of embedding models, wherein the instructions, when executed by the one or more computing devices, further cause:
for each embedding model of the plurality of embedding models:
generating a particular embedding using said each embedding model and the input document as input to said each embedding model;
based on the particular embedding, identifying a particular plurality of embeddings;
generating one or more particular clusters of embeddings from the particular plurality of embeddings;
identifying a particular cluster, from the one or more particular clusters, that includes the particular embedding;
based on the particular embedding, identifying, in the cluster, a first particular set of embeddings and a second particular set of embeddings;
for each embedding in the first particular set of embeddings:
selecting, from the second particular set of embeddings, a certain embedding based on a similarity score between said each embedding an the certain embedding;
identifying a first particular document that is associated with the certain embedding;
generating a particular training instance that includes the first particular document;
adding the particular training instance to the set of training data.

18. The one or more storage media of claim 13, wherein the second set of embeddings is a first subset of a first plurality of embeddings that were identified in the cluster based on the document embedding, wherein the instructions, when executed by the one or more computing devices, further cause:
identifying a second subset of the first plurality of embeddings;
identifying a set of ensemble embeddings that correspond to the second subset;
based on the query, generating a query embedding that represents the query;
for each ensemble embedding in the set of ensemble embeddings:
generating a similarity score between said each ensemble embedding and the query embedding;
adding the similarity score to a set of similarity scores;
selecting a subset of the set of similarity scores;
identifying a plurality of documents that are associated with the subset;
generating a plurality of training instances based on the plurality of documents;
adding the plurality of training instances to the set of training data.

19. The one or more storage media of claim 18, wherein the query embedding is an ensemble embedding that is based on multiple embeddings that were generated based on output from each embedding model of a plurality of embedding models that includes the embedding model.

20. The one or more storage media of claim 13, wherein the instructions, when executed by the one or more computing devices, further cause:
identifying a subset of the first set of embeddings;
identifying a plurality of positive documents that are associated with the subset;
generating a plurality of training instances based on the plurality of positive documents;
adding the plurality of training instances to the set of training data.
